(19) United States
(12) Patent Application Publication
(10) Pub. No.: US 2024/0332802 A1
(43) Pub. Date: Oct. 3, 2024

(54) ANTENNA ASSEMBLY, AN APPARATUS COMPRISING THE ANTENNA ASSEMBLY, AND A METHOD OF MANUFACTURING THE ANTENNA ASSEMBLY

(71) Applicant: HUAWEI TECHNOLOGIES CO., LTD., Shenzhen (CN)

(72) Inventors: Ruiyuan Tian, Helsinki (FI); Konstantin Sokolov, Helsinki (FI); Alexander Khripkov, Helsinki (FI); Timofey Kamyshev, Helsinki (FI); Janne Ilvonen, Helsinki (FI); Zlatoljub Milosavljevic, Helsinki (FI); Hanyang Wang, Reading (GB); Joonas Krogerus, Helsinki (FI)

(21) Appl. No.: 18/741,479

(22) Filed: Jun. 12, 2024

Related U.S. Application Data
(63) Continuation of application No. PCT/EP2021/085887, filed on Dec. 15, 2021.

(51) Int. Cl. H01Q 9/04; H01Q 21/08

(52) U.S. Cl. CPC H01Q 9/0414; H01Q 9/0457; H01Q 21/08

(57) ABSTRACT

An antenna assembly, an apparatus having the antenna assembly, and a method of manufacturing the antenna assembly are disclosed. Antenna performance in, e.g., mobile devices is improved via an antenna assembly which allows wide-angle beam scanning across a wide frequency bandwidth. Wide beam coverage may in turn contribute to improving multi-surface spherical beam coverage, such as in broadside direction and endfire direction, and to reducing the amount of needed antenna modules. A tightly-coupled dipole array exhibits wide operating frequency bandwidth characteristics.

### CROSS-REFERENCE TO RELATED APPLICATIONS

This application is a continuation of International Application No. PCT/E2021/085887, filed on Dec. 15, 2021, the disclosure of which is hereby incorporated by reference in its entirety.

### TECHNICAL FIELD

The present disclosure relates to the field of antennas, and, more particularly, to an antenna assembly, an apparatus comprising the antenna assembly, and a method of manufacturing the antenna assembly.

### BACKGROUND

So called millimeter wave (mmWave) bands (frequency range approximately 30 to 300 gigahertz, and wavelength range 1 cm to 1 mm) have been used, e.g., in point-to-point communications, intersatellite links, and point-to-multipoint communications. They are starting to be implemented in various fifth generation (5G) wireless network systems also.

In mmWave frequencies, an antenna array may be used to form an antenna beam with a higher gain to overcome a higher path loss in the propagation media. However, radiation and beam patterns of such an antenna array with the higher gain may result in a narrower beam width.

To overcome or at least reduce the effects of the narrower beam width, beam steering techniques, such as a phased antenna array may be utilized to steer the antenna beam towards a different direction on demand.

Furthermore, 5G mmWave is planned to support a minimum dual layer to fulfil demodulation performance requirements. Specifically, a 5G user equipment (UE) is to use omni-coverage mmWave antennas with generally constant effective isotropic radiated power (EIRP) or effective isotropic sensitivity (EIS), diversity, and multiple-input and multiple-output (MIMO) performance to achieve stable communication in all directions and orientations. These requirements for omni-coverage result from, e.g., enhanced mobile broadband (eMBB) dense urban use-cases in which there is a high probability for loss of signal (LOS) between a UE and a small cell base station (BS) or consumer premises equipment (CPE). Typically, a non-line-of-sight channel may have at least 20 dB higher attenuation in comparison with a line-of-sight channel. Therefore, dual layers supported by a single polarization UE in a non-line-of-sight channel would result in a degraded data throughput.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective of the present disclosure to improve antenna performance in mobile devices via an antenna assembly which allows wide-angle beam scanning across a wide frequency bandwidth. The foregoing and other objectives are achieved by the features of the independent claims. Further implementation forms are apparent from the dependent claims, the description and the figures.

According to a first aspect of the present disclosure, an antenna assembly is provided. The antenna assembly comprises an array of unit-cells. Each unit-cell comprises a ground plane layer defining a ground plane. Each unit-cell further comprises a dipole antenna layer that defines a dipole antenna plane parallel to the ground plane. The dipole antenna layer comprises at least a first dipole antenna. Each unit-cell further comprises a capacitive feed probe that is configured to be electromagnetically coupled to an aperture of at least the first dipole antenna. Each first dipole antenna is arranged so as to be configurable in a linear-polarized manner along a length-wise direction of the array of the unit-cells. The unit-cells are arranged in a periodically repeating manner along at least the length-wise direction, so as to configure a tightly-coupled dipole array. The present disclosure allows improving antenna performance in, e.g., mobile devices via an antenna assembly which allows wide-angle beam scanning across a wide frequency bandwidth. Wide beam coverage may in turn contribute to improving multi-surface spherical beam coverage, such as in broadside direction and endfire direction, and to reducing the amount of needed antenna modules. Specifically, the disclosed capacitive feed probe allows the tightly-coupled dipole array to achieve the wide-angle beam scanning. The tightly-coupled dipole array also exhibits wide operating frequency bandwidth characteristics.

In an implementation form of the first aspect, each unit-cell further comprises a floating patch layer defining a floating patch plane parallel to the dipole antenna plane and the ground plane, the floating patch layer comprising a floating patch having two separate floating patch elements above the first dipole antenna. The disclosed floating patch layer allows controlling an achievable frequency bandwidth with a desired pitch.

In an implementation form of the first aspect, the unit-cells being arranged in the periodically repeating manner along at least the length-wise direction comprises arranging the unit-cells such that a floating patch element in a unit-cell is connected to the nearest floating patch element in a neighboring unit-cell. This implementation form allows achieving the tightly-coupled dipole array which in turn exhibits wide angle beam steering and wide frequency bandwidth characteristics.

In an implementation form of the first aspect, the two floating patch elements in a floating patch are separated by a gap between the two floating patch elements in the length-wise direction. This implementation form allows more freedom to design an optimal pitch for desired gain and beam scanning properties of an implemented array of unit-cells.

In an implementation form of the first aspect, each unit-cell has a pitch defined by a span of the corresponding floating patch in the length-wise direction. The present disclosure allows improving antenna performance in, e.g., mobile devices via an antenna assembly which allows wide-angle beam scanning across a wide frequency bandwidth.

In an implementation form of the first aspect, the at least first dipole antenna has a length shorter than the pitch of the respective unit-cell. The present disclosure allows improving antenna performance in, e.g., mobile devices via an antenna assembly which allows wide-angle beam scanning across a wide frequency bandwidth.

In an implementation form of the first aspect, the ground plane layer of a unit-cell has a span in the length-wise direction equal to the pitch of the respective unit-cell. The present disclosure allows improving antenna performance in, e.g., mobile devices via an antenna assembly which allows wide-angle beam scanning across a wide frequency bandwidth.

In an implementation form of the first aspect, the first dipole antenna is associated with a first polarization, and the dipole antenna layer further comprises a primary second dipole antenna associated with a second polarization. The first dipole antenna and the primary second dipole antenna are arranged perpendicular to each other and co-centered to each other at different heights in the dipole antenna layer. This implementation form allows dual-polarization, with design parameters of each polarization tuned differently if desired.

In an implementation form of the first aspect, the dipole antenna layer further comprises a secondary second dipole antenna associated with the second polarization and arranged perpendicular to the first dipole antenna at a same height as the primary second dipole antenna and centered at a mid-point of two neighboring first dipole antennas. The secondary second dipole antenna is further arranged so as to form an array along the length-wise direction. This implementation form further allows dual-polarization, with design parameters of each polarization tuned differently if desired.

In an implementation form of the first aspect, the antenna assembly is dual-polarized, such that the first polarization is perpendicular to the second polarization. The disclosed tightly-coupled and dual-polarized dipole array allows achieving wide scanning for both polarizations.

In an implementation form of the first aspect, at least one of the first dipole antenna, the primary second dipole antenna or the secondary second dipole antenna comprises at least one slot in at least one dipole branch. This implementation form allows more freedom to design an optimal pitch for desired gain and beam scanning properties of an implemented array of unit-cells.

In an implementation form of the first aspect, the capacitive feed probe comprises a via from a feed line above the ground plane layer towards the dipole antenna layer. The disclosed capacitive feed probe allows achieving the wide-angle beam scanning.

In an implementation form of the first aspect, the antenna assembly comprises a millimeter wave, mmWave, antenna assembly. The present disclosure allows improving antenna performance in, e.g., mobile devices via an antenna assembly which allows wide-angle beam scanning across a wide frequency bandwidth.

According to a second aspect of the present disclosure, an apparatus is provided. The apparatus comprises the antenna assembly according to the first aspect of the present disclosure. The present disclosure allows improving antenna performance in, e.g., mobile devices via an antenna assembly which allows wide-angle beam scanning across a wide frequency bandwidth.

In an implementation form of the second aspect, the apparatus further comprises a client device or a customer-premises equipment. This implementation form allows improving antenna performance in, e.g., client devices and customer-premises equipment via an antenna assembly which allows wide-angle beam scanning across a wide frequency bandwidth.

According to a third aspect of the present disclosure, a method of manufacturing an antenna assembly is provided. The method of manufacturing the antenna assembly comprises arranging, on a multilayer printed circuit board, PCB, a ground plane layer defining a ground plane in a unit-cell of an array of unit-cells. The method further comprises arranging, on the multilayer PCB, a dipole antenna layer defining a dipole antenna plane parallel to the ground plane, the dipole antenna layer comprising at least a first dipole antenna, each first dipole antenna arranged so as to be configurable in a linear-polarized manner along a length-wise direction of the array of the unit-cells. The method further comprises arranging, on the multilayer PCB, a capacitive feed probe configured to be electromagnetically coupled to an aperture of at least the first dipole antenna. The method further comprises arranging, on the multilayer PCB, the unit-cells in a periodically repeating manner along at least the length-wise direction, so as to configure a tightly-coupled dipole array. The present disclosure allows improving antenna performance in, e.g., mobile devices via an antenna assembly which allows wide-angle beam scanning across a wide frequency bandwidth. Wide beam coverage may in turn contribute to improving multi-surface spherical beam coverage, such as in broadside direction and endfire direction, and to reducing the amount of needed antenna modules. Specifically, the disclosed capacitive feed probe allows the tightly-coupled dipole array to achieve the wide-angle beam scanning. The tightly-coupled dipole array also exhibits wide operating frequency bandwidth characteristics.

Many of the features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIGS. 1A-1D are diagrams illustrating mmWave antenna array module configurations of a user equipment;

FIGS. 2A-2D are diagrams illustrating antenna assemblies and unit-cells, according to embodiments of the disclosure;

FIG. 3 is a diagram illustrating an achieved operating frequency bandwidth of the disclosed unit-cell antenna with a periodic boundary condition;

FIGS. 4A-4B are diagrams illustrating the disclosed tightly-coupled dipole array;

FIG. 5 is a diagram illustrating tuning of the disclosed unit-cell antenna;

FIGS. 6-7 are diagrams illustrating achieved gain for a wide scan angle at both 27 GHz and 40 GHz;

FIGS. 8A-8B are diagrams illustrating the disclosed dipole antennas in close-up;

FIGS. 9-11 are diagrams illustrating the disclosed capacitive feed probes;

FIG. 12 is a block diagram illustrating an apparatus according to an embodiment of the disclosure; and

FIG. 13 is a flow diagram illustrating a method of manufacturing according to an embodiment of the present disclosure.

In the following, identical reference signs refer to identical or at least functionally equivalent features.

### DETAILED DESCRIPTION

In the following description, reference is made to the accompanying drawings, which form part of the disclosure and show, by way of illustration, specific aspects of the present disclosure. It is understood that other aspects may be utilized and structural or logical changes may be made without departing from the scope of the present disclosure. The following detailed description, therefore, is not to be taken in a limiting sense, as the scope of the present disclosure is defined in the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus or device is described based on functional units, a corresponding method may include a step performing the described functionality, even if such step is not explicitly described or illustrated in the figures. Further, it is understood that the features of the various example aspects described herein may be combined with each other, unless specifically noted otherwise.

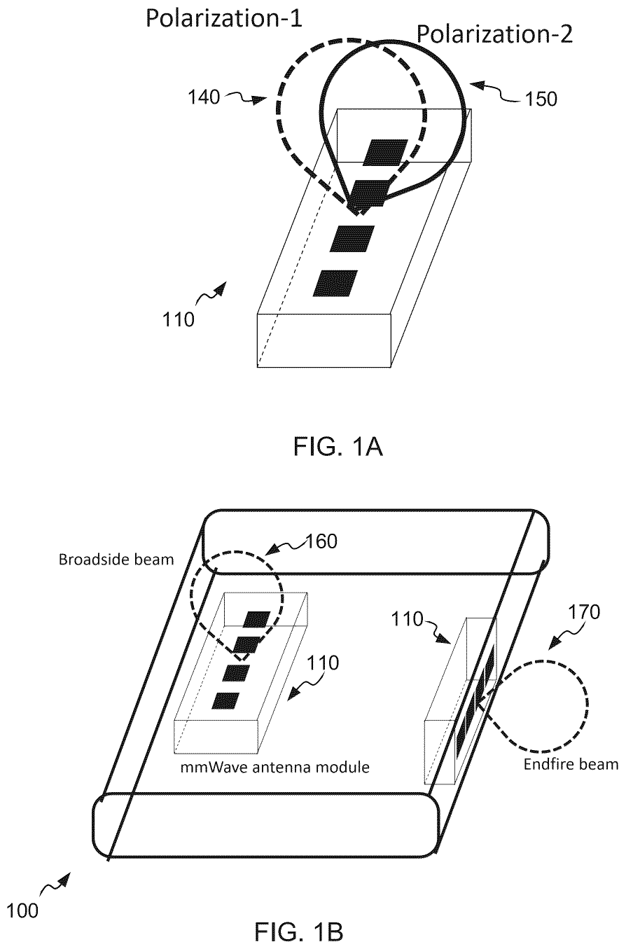

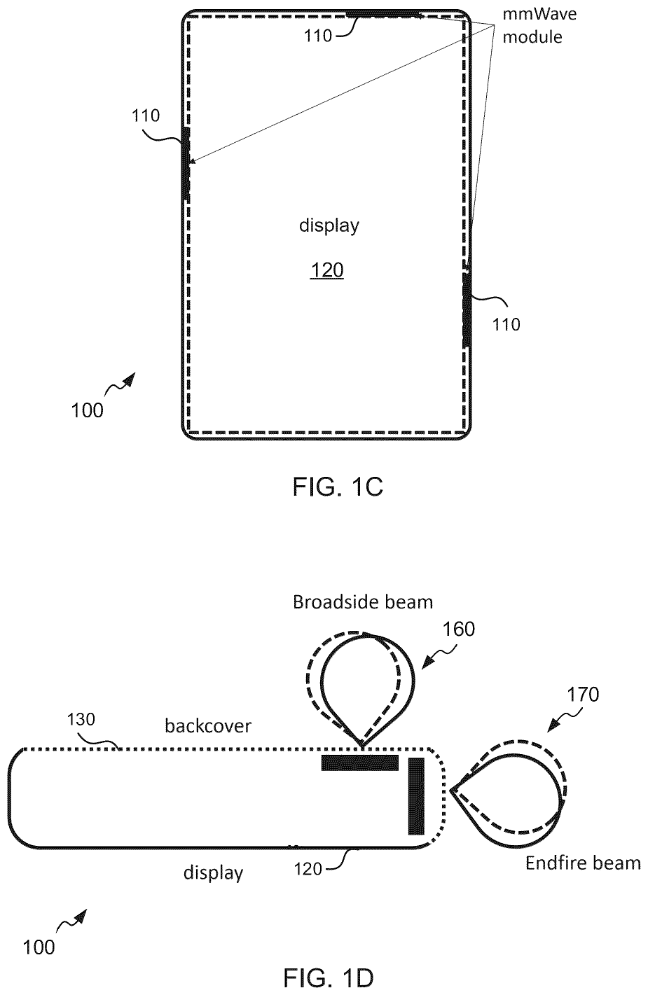

Conventionally, a millimeter wave (mmWave) antenna may be implemented in an mmWave antenna module 110, as illustrated in FIGS. 1A-1D. The mmWave antenna module 110 may then be assembled to a main circuit board of, e.g., a user equipment (UE) 100 having a display 120 and a back cover 130. The mmWave antenna module 110 may comprise a printed circuit board (PCB) in which an mmWave antenna array is implemented. The PCB may comprise an antenna array in which a main radiation beam direction is a broadside 160 direction, i.e., a direction perpendicular to the display 120 of the UE 100. Alternatively, the PCB may be assembled vertically flipped so that the main radiation beam direction is an endfire 170 direction, i.e., a direction parallel to the display of the UE 100. The mmWave antenna module 110 may further comprise a radio-frequency integrated circuit (RFIC). Alternatively, the RFIC and the antenna PCB may be integrated in a single package. A number of mmWave antenna modules 110 may be placed at different locations in the UE 100.

At least in some situations, the mmWave antenna module 110 may be required to sufficiently cover as much of a sphere as possible. Thus, dual-polarized antenna radiation may be needed in which each polarization 140, 150 is utilized by an independent data stream of a baseband modem to facilitate MIMO communications. Here, dual-polarized means that an antenna has two polarizations 140, 150 (e.g., a horizontal polarization and a vertical polarization, or more generally a polarization 1 and a polarization 2) in a single direction.

The integration of such a module of antennas and an RFIC into a UE may be challenging due to the limited space available. At the same time, at least a couple of modules may be needed in order to achieve good multi-surface spherical beam coverage, such as the broadside 160 and endfire 170 coverage. Capability to achieve wide beam coverage is desirable, since it may contribute to improvement of the spherical coverage and potentially allow reducing the amount of antenna modules needed. However, a conventional phased array of half-wavelength spacing may have a limited beam scanning range, especially across a wide frequency bandwidth. It may not be possible to attain half-wavelength spacing for a wide frequency bandwidth. This remains a challenge especially when it comes to dual-polarization and wide frequency bandwidth.

As will be discussed in more detail below, the present disclosure provides a dual-polarized mmWave beam-steering antenna array with wide-angle beam scanning across a wide frequency bandwidth.

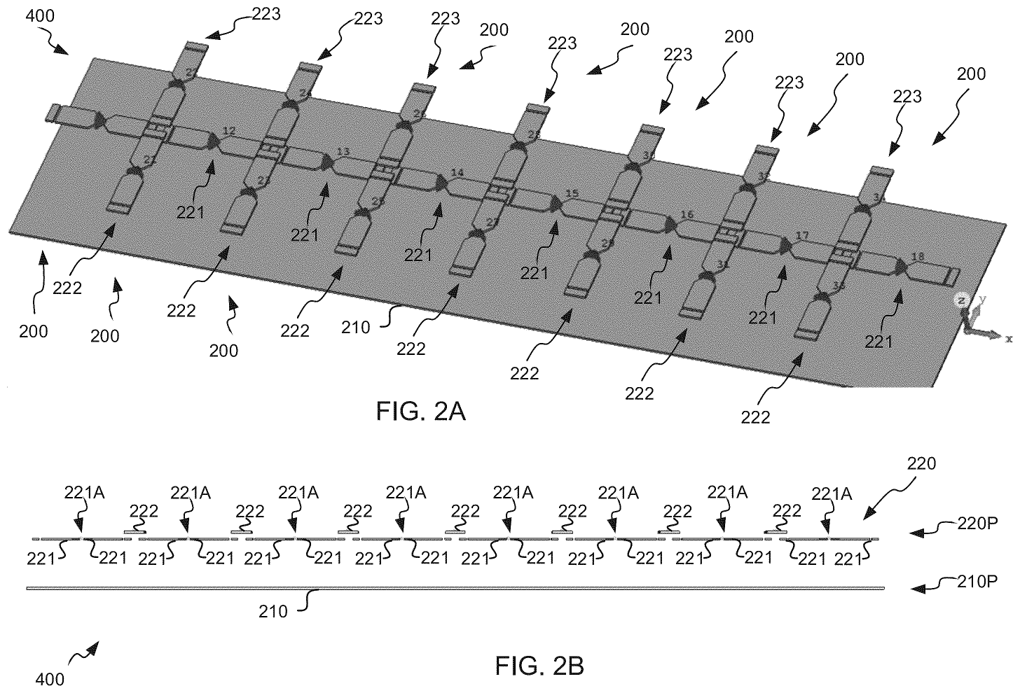

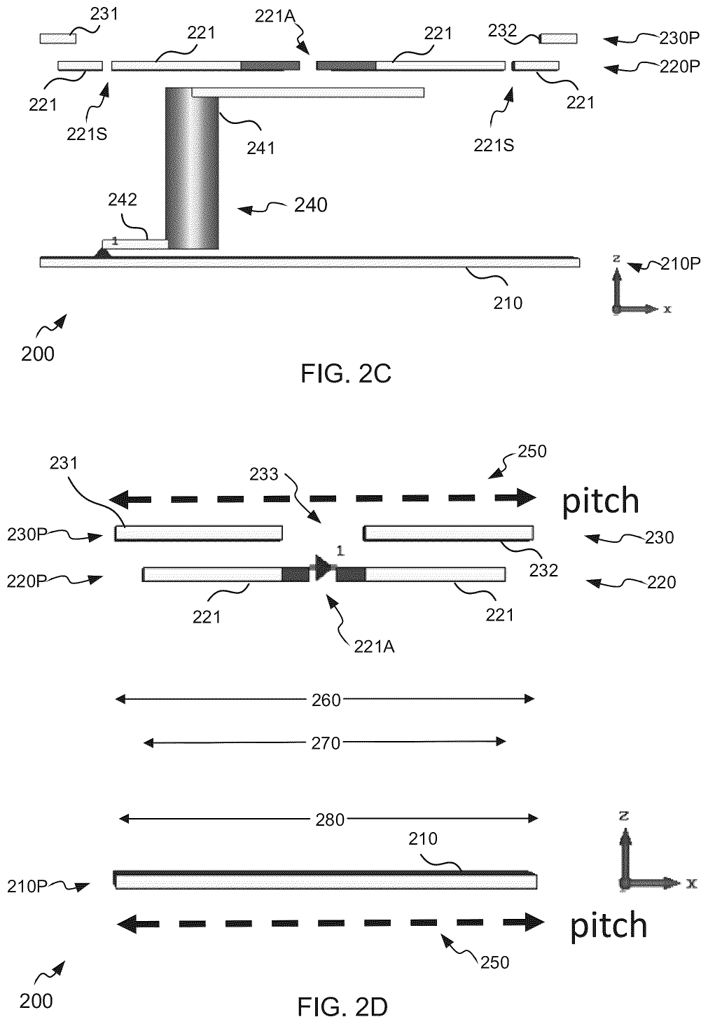

Next, example embodiments of an antenna assembly 400 and unit-cell 200 are described based on FIGS. 2A-2D. Some of the features of the described devices are optional features which provide further advantages.

FIGS. 2A-2D are diagrams illustrating antenna assemblies 400 and unit-cells 200, according to embodiments of the disclosure. For example, the antenna assembly 400 may comprises an mmWave antenna assembly. For example, the antenna assembly 400 may be implemented on a PCB stackup with a number of conductor layers and substrate layers. In FIGS. 2A, 2D, 4A-4B, 5 and 8A-8B, the numbers close to the diple antenna apertures indicate associated example port indices.

The antenna assembly 400 comprises an array of unit-cells 200. Each unit-cell 200 comprises a ground plane layer 210 defining a ground plane 210P.

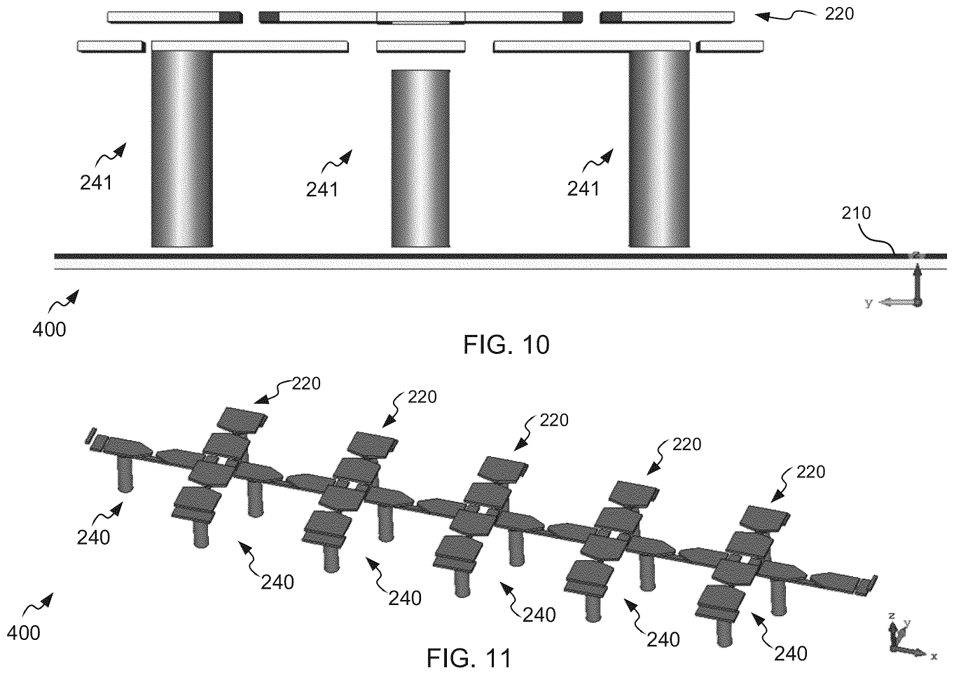

Each unit-cell 200 further comprises a dipole antenna layer 220 that defines a dipole antenna plane 220P parallel to the ground plane 210P. The dipole antenna layer 220 comprises at least a first dipole antenna 221. Herein, each first dipole antenna 221 comprises two conductive elements or branches extending in a length-wise direction, with an aperture 221A in the middle of the two branches. The length-wise direction is indicated with an ‘x’ in FIGS. 2A-2D, 4A-4B, 8A-8B and 9-11.

Each unit-cell 200 further comprises a capacitive feed probe 240 that is configured to be electromagnetically coupled to an aperture 221A of at least the first dipole antenna 221 (and/or an aperture of a primary second dipole antenna 222 and/or an aperture of a secondary second dipole antenna 223), as illustrated in FIGS. 2C, and 9-11. For example, the capacitive feed probe 240 may comprise a via 241 from a feed line 242 above the ground plane layer 210 towards the dipole antenna layer 220. For example, the capacitive feed probe 240 may comprise an L-shaped capacitive feed probe. The capacitive feed probe 240 may provide an excitation source.

In other words, the feeding may be realized by the via 241 and by the presence of the capacitive feed probe 240 with its horizontal current distribution, which coupled to the dipole aperture 221A, allows maintaining the advantageous beam scan properties of the disclosed array of unit-cells 200.

Each unit-cell 200 may further comprise a floating patch layer 230 that defines a floating patch plane 230P parallel to the dipole antenna plane 220P and the ground plane 210P. The floating patch layer 230 may comprise a floating patch having two separate floating patch elements 231, 232 above the first dipole antenna 221. The floating patch may also be referred to as a floating patch coupler or connected-array.

At least in some embodiments, the dipole antenna plane 220P may be arranged between the ground plane 210P and the floating patch plane 230P.

As shown in FIG. 2D, at least in some embodiments each unit-cell 200 may have a pitch 250 defined by a span 260 of the corresponding floating patch in the length-wise direction. At least in some embodiments, the at least first dipole antenna 221 may have a length 270 shorter than the pitch 250 of the respective unit-cell 200. At least in some embodiments, the ground plane layer 210 of a unit-cell 200 may have a span 280 in the length-wise direction equal to the pitch 250 of the respective unit-cell 200.

Each first dipole antenna 221 is arranged so as to be configurable in a linear-polarized manner along the length-wise direction of the array of the unit-cells 200. Herein, the term “linear polarization” refers to a polarization that occurs when electromagnetic waves broadcast on a single plane-either vertical or horizontal.

Furthermore, the unit-cells 200 are arranged in a periodically repeating manner (i.e., so that a boundary of the unit-cell 200 satisfies a periodic boundary condition) along at least the length-wise direction, so as to configure a tightly-coupled (or even-connected or densely packed) dipole array.

At least in some embodiments, the unit-cells 200 may be arranged in a periodically repeating manner along the length-wise direction (i.e., x-direction in the figures) and along a direction perpendicular to the length-wise direction in the ground plane 210P (i.e., y-direction in the figures), so as to configure a tightly-coupled “two-dimensional” dipole array (i.e., two-dimensional in the sense that unit-cells repeat periodically in two directions). Such a tightly-coupled two-dimensional dipole array may be implemented in, e.g., a customer-premises equipment (CPE)/a fixed wireless access (FWA) device, or the like in which space requirements allow using a two-dimensional dipole array.

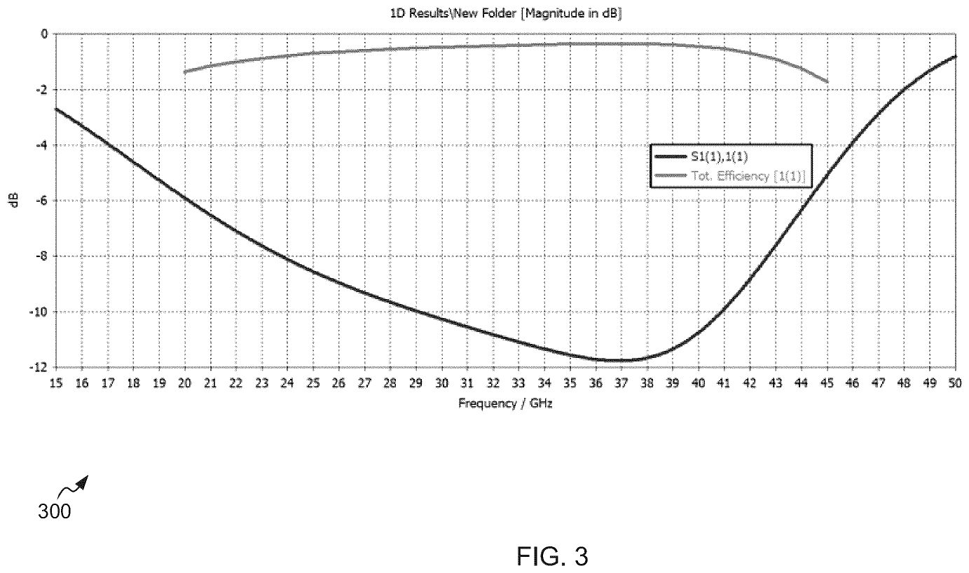

At least in some embodiments, the above-described structure of the antenna assembly 400 may exhibits wide operating frequency bandwidth characteristics, as shown in diagram 300 of FIG. 3 which illustrates an achieved operating frequency bandwidth of the disclosed unit-cells 200 satisfying the periodic boundary condition.

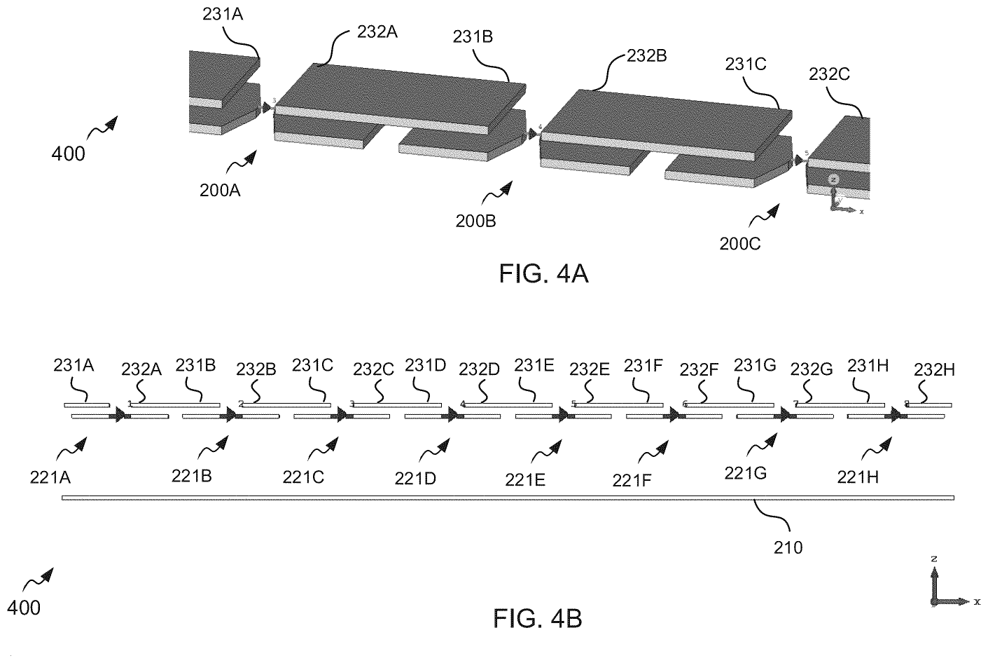

At least in some embodiments, the unit-cells 200 being arranged in the periodically repeating manner along at least the length-wise direction may comprise arranging the unit-cells 200 such that a floating patch element 232A in a unit-cell 200A is connected to the nearest floating patch element 231B in a neighboring unit-cell 200B, as illustrated in FIGS. 4A-4B which show an example implementation of an array with a finite number (8) of antenna elements. The array may be implemented on a PCB stackup. The floating patch element 232A from one unit-cell 200A is connected to the nearest floating patch element 231B from a neighboring unit-cell 200B. The length of the formed dipole array is N (N=8) times the pitch 250. Since the antenna is a dipole, the resonance frequency and the obtained operation frequency bandwidth would conventionally be tuned by the length of the dipole. E.g., in the case of a tightly-coupled array, conventional tuning may involve simultaneous excitation of antenna ports. However, with the floating patch elements, it is possible to tune the pitch 250 of the unit-cell 200 such that the targeted frequency band may be supported with the desired pitch. In some embodiments, it may have the pitch 250 correspond more to the higher end frequency of the operation bandwidth in order to achieve a wide-angle scan range across the entire frequency bandwidth. However, in other embodiments, in order to achieve a given realized gain with a reasonable number of feedings, it may have the pitch 250 correspond more to the lower end of the frequency band so that the aperture of the implemented array is large enough for a given gain target.

At least in some embodiments, the length/span of each first dipole antenna 221 may be only slightly shorter than that of a corresponding ground plane layer 210 in a unit-cell 200, hence the first dipole antennas are tightly coupled when forming an array using multiple unit-cells. An example of this may include an embodiment without the above-described floating patch element 232A from one unit-cell 200A connected to the nearest floating patch element 231B from the neighboring unit-cell 200B.

At least in some embodiments, the two floating patch elements 231, 232 in a floating patch may be separated by a gap 233 between the two floating patch elements 231, 232 in the length-wise direction.

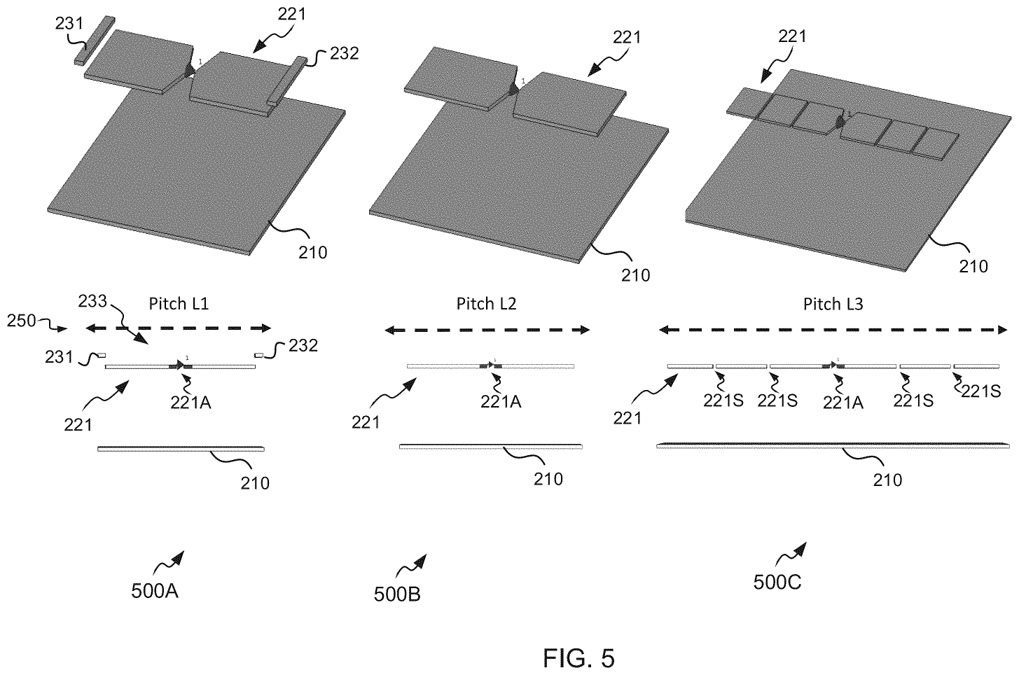

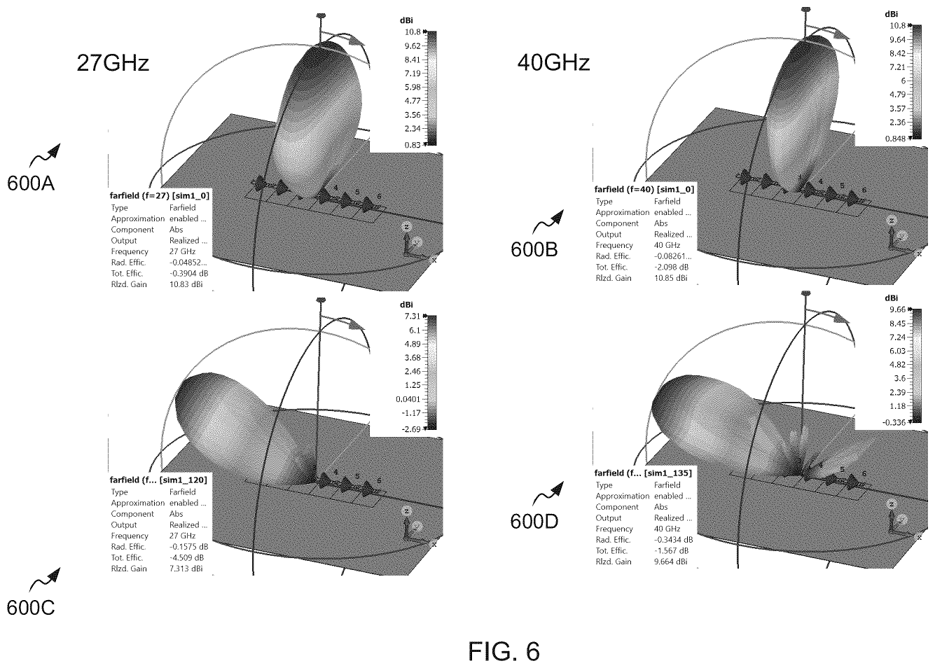

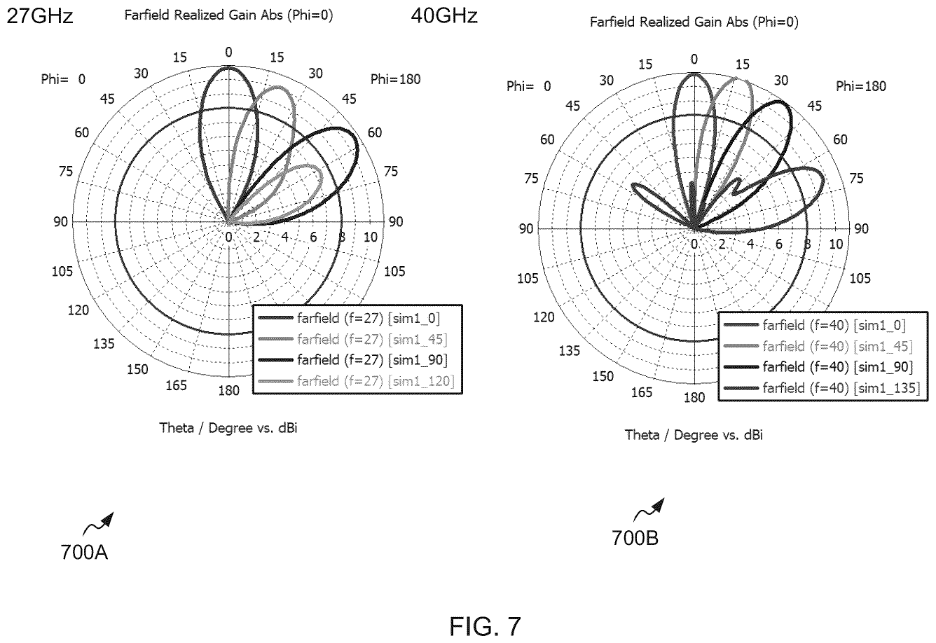

For example, the floating patch elements 231, 232 may be tuned to be smaller, such that there is a large gap 233 between the two patch elements 231, 232, with, e.g., a pitch L1, as illustrated in diagram 500A of FIG. 5. It is also possible to eliminate the floating patch elements 231, 232, with, e.g., a pitch L2, as illustrated in diagram 500B of FIG. 5. Additionally/alternatively, multiple slots 221S may be introduced on the dipole branches, with, e.g., a pitch L3, as illustrated in diagram 500C of FIG. 5. For the same targeted frequency bandwidth, the corresponding pitch 250 required for each of the above-mentioned three embodiments may have the following relationship: pitch L1<L2<L3. With these embodiments, there may be more freedom to design an optimal pitch 250 for the desired gain and beam scanning properties of the implemented array. Examples of achieved gain and beam scan range of the implemented array are illustrated in diagrams 600A-600D of FIG. 6 and diagrams 700A-700B of FIG. 7, with higher than 8 dBi gain for a wide scan angle of almost 75 degrees at both 27 gigahertz (GHz) and 40 GHz.

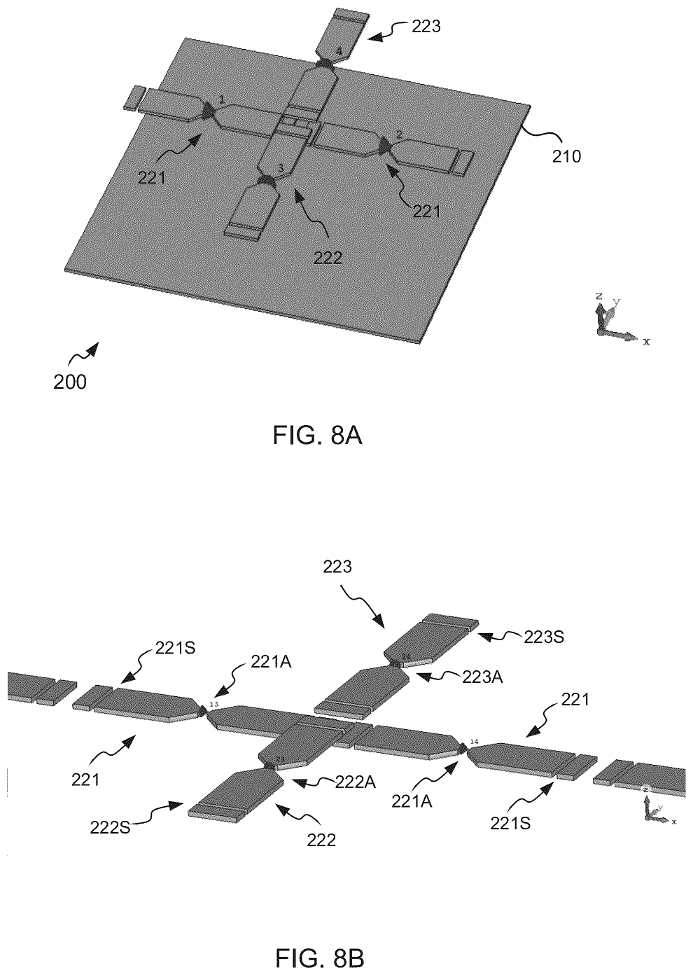

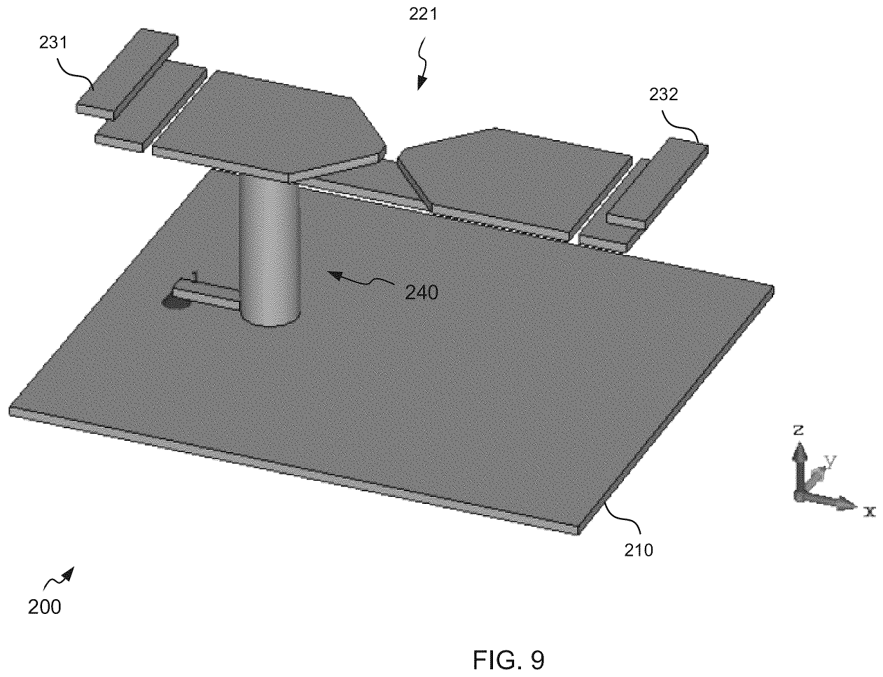

At least in some embodiments, the antenna assembly 400 may be dual-polarized, such that a first polarization (e.g., horizontal polarization) is perpendicular to a second polarization (e.g., vertical polarization). For example, the first dipole antenna 221 may be associated with the first polarization, and the dipole antenna layer 220 may further comprise the primary second dipole antenna 222 associated with the second polarization. The first dipole antenna 221 and the primary second dipole antenna 222 may be arranged perpendicular to each other, and co-centered to each other at different heights in the dipole antenna layer 220, as illustrated in FIGS. 8A-8B. For example, the dipole-pair for each polarization may be placed at different layers of the PCB stackup, corresponding to the first and second polarizations.

At least in some embodiments, the dipole antenna layer 220 may further comprise the secondary second dipole antenna 223 associated with the second polarization and arranged perpendicular to the first dipole antenna 221 at a same height as the primary second dipole antenna 222 and centered at a mid-point of two neighboring first dipole antennas. The secondary second dipole antenna 223 may be further arranged so as to form an array along the length-wise direction.

In other words, in order to improve the scan range for the second polarization, additional second polarization antenna elements (e.g., the 2nd, 4th and 6th secondary second dipole antennas 223 in the example embodiment of FIG. 2A) may be utilized, reducing the pitch of the second polarization antenna array by half. With such an embodiment, both polarizations may achieve an excellent realized gain performance with a wide beam scan range larger than 60 degrees.

At least in some embodiments, at least one of the first dipole antenna 221, the primary second dipole antenna 222 or the secondary second dipole antenna 223 may comprise at least one slot 221S, 222S, 223S in at least one dipole branch.

Thus, at least in some embodiments, the array of unit cells 200 may have dual-polarization, and the design parameters of each polarization may be tuned differently. This may be desirable, e.g., in order to fulfill a design target for the occupied area of the array. In this case, a width in the y-direction (i.e., the direction perpendicular to the length-wise direction in the ground plane 210P) may be made narrower in order to be able to fit into the endfire area of the apparatus 1200, for example. This may be achieved by tuning parameters, as discussed in connection with FIG. 5.

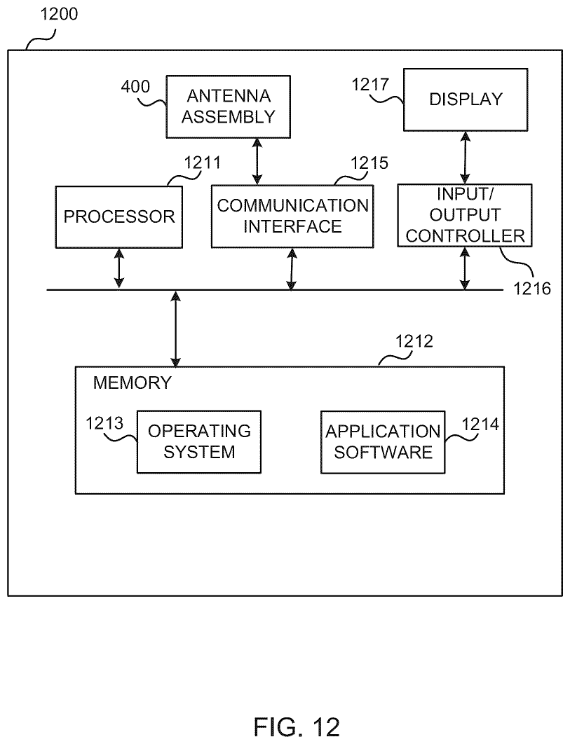

FIG. 12 is a block diagram illustrating an apparatus 1200 according to an embodiment of the disclosure. The apparatus 1200 comprises the antenna assembly 400. The apparatus 1200 may further comprise, e.g., a client device or a customer-premises equipment (CPE), such as a fixed wireless access (FWA) device.

The apparatus 1200 may further comprise one or more processors 1211 and one or more memories 1212 that may comprise computer program code. The apparatus 1200 may also include other elements, such as a display 1217, a communication interface 1215 and an input/output controller 1216, as well as other elements not shown in FIG. 12.

Although the apparatus 1200 is depicted to include only one processor 1211, the apparatus 1200 may include more processors. In an embodiment, the memory 1212 is capable of storing instructions, such as an operating system 1213 and/or various applications 1214. Furthermore, the memory 1212 may include a storage.

Furthermore, the processor 1211 is capable of executing the stored instructions. In an embodiment, the processor 1211 may be embodied as a multi-core processor, a single core processor, or a combination of one or more multi-core processors and one or more single core processors. For example, the processor 1211 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 1211 may be configured to execute hard-coded functionality. In an embodiment, the processor 1211 is embodied as an executor of software instructions.

The memory 1212 may be embodied as one or more volatile memory devices, one or more non-volatile memory devices, and/or a combination of one or more volatile memory devices and non-volatile memory devices. For example, the memory 1212 may be embodied as semiconductor memories (such as mask ROM, PROM (programmable ROM), EPROM (erasable PROM), flash ROM, RAM (random access memory), etc.).

The apparatus 1200 comprising the client device may include, e.g., any of various types of devices used directly by an end user entity and capable of communication in a wireless network, such as user equipment (UE). Such devices include but are not limited to smartphones, tablet computers, smart watches, internet-of-things (IoT) devices, enhanced mobile broadband (eMBB) devices, etc.

Further features of the apparatus 1200 related to the antenna assembly 400 directly result from the features and parameters of the antenna assembly 400 and thus are not repeated here.

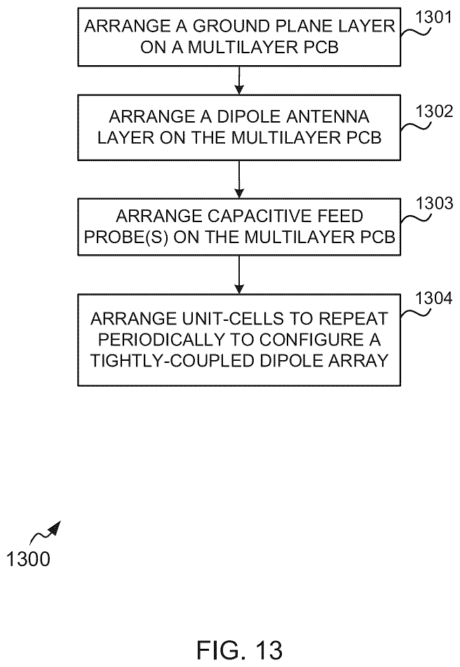

FIG. 13 is a flow diagram illustrating a method 1300 of manufacturing the antenna assembly 400 according to an embodiment of the present disclosure.

At operation 1301, a ground plane layer defining a ground plane in a unit-cell of an array of unit-cells is arranged on a multilayer printed circuit board (PCB).

At operation 1302, a dipole antenna layer defining a dipole antenna plane parallel to the ground plane is arranged on the multilayer PCB. The dipole antenna layer comprises at least a first dipole antenna, each first dipole antenna arranged so as to be configurable in a linear-polarized manner along a length-wise direction of the array of the unit-cells.

At operation 1303, a capacitive feed probe configured to be electromagnetically coupled to an aperture of at least the first dipole antenna is arranged on the multilayer PCB.

At operation 1304, the unit-cells are arranged on the multilayer PCB in a periodically repeating manner along at least the length-wise direction, so as to configure a tightly-coupled dipole array.

Further features of the method 1300 directly result from the features and parameters of the antenna assembly 400 and thus are not repeated here.

Any range or device value given herein may be extended or altered without losing the effect sought. Further, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of example embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. An antenna assembly, comprising:
an array of unit-cells, each unit-cell comprising:
a ground plane layer defining a ground plane;
a dipole antenna layer defining a dipole antenna plane parallel to the ground plane, the dipole antenna layer comprising at least a first dipole antenna; and
a capacitive feed probe configured to be electromagnetically coupled to an aperture of at least the first dipole antenna,
wherein:
each first dipole antenna is arranged so as to be configurable in a linear-polarized manner along a length-wise direction of the array of the unit-cells, and
the unit-cells are arranged in a periodically repeating manner along at least the length-wise direction, so as to configure a tightly-coupled dipole array.

2. The antenna assembly according to claim 1, wherein each unit-cell further comprises a floating patch layer defining a floating patch plane parallel to the dipole antenna plane and the ground plane, the floating patch layer comprising a floating patch having two separate floating patch elements above the first dipole antenna.

3. The antenna assembly according to claim 2, wherein the unit-cells being arranged in the periodically repeating manner along at least the length-wise direction comprises arranging the unit-cells such that a floating patch element in a unit-cell is connected to the nearest floating patch element in a neighboring unit-cell.

4. The antenna assembly according to claim 2, wherein the two floating patch elements in a floating patch are separated by a gap between the two floating patch elements in the length-wise direction.

5. The antenna assembly according claim 2, wherein each unit-cell has a pitch defined by a span of the corresponding floating patch in the length-wise direction.

6. The antenna assembly according to claim 5, wherein the at least first dipole antenna has a length shorter than the pitch of the respective unit-cell.

7. The antenna assembly according to claim 5, wherein the ground plane layer of a unit-cell has a span in the length-wise direction equal to the pitch of the respective unit-cell.

8. The antenna assembly according to claim 1, wherein the first dipole antenna is associated with a first polarization, and the dipole antenna layer further comprises a primary second dipole antenna associated with a second polarization, the first dipole antenna and the primary second dipole antenna arranged perpendicular to each other and co-centered to each other at different heights in the dipole antenna layer.

9. The antenna assembly according to claim 8, wherein the dipole antenna layer further comprises a secondary second dipole antenna associated with the second polarization and arranged perpendicular to the first dipole antenna at a same height as the primary second dipole antenna and centered at a mid-point of two neighboring first dipole antennas, and wherein the secondary second dipole antenna is further arranged so as to form an array along the length-wise direction.

10. The antenna assembly according to claim 9, wherein the antenna assembly is dual-polarized, such that the first polarization is perpendicular to the second polarization.

11. The antenna assembly according to claim 9, wherein at least one of the first dipole antenna, the primary second dipole antenna or the secondary second dipole antenna comprises at least one slot in at least one dipole branch.

12. The antenna assembly according to claim 1, wherein the capacitive feed probe comprises a via from a feed line above the ground plane layer towards the dipole antenna layer.

13. The antenna assembly according to claim 1, wherein the antenna assembly comprises a millimeter wave, mmWave, antenna assembly.

14. An apparatus, comprising the antenna assembly according to claim 1.

15. The apparatus according to claim 14, further comprising a client device or a customer-premises equipment.

16. A method of manufacturing an antenna assembly, the method comprising:
arranging, on a multilayer printed circuit board, PCB, a ground plane layer defining a ground plane in a unit-cell of an array of unit-cells;
arranging, on the multilayer PCB, a dipole antenna layer defining a dipole antenna plane parallel to the ground plane, the dipole antenna layer comprising at least a first dipole antenna, each first dipole antenna arranged so as to be configurable in a linear-polarized manner along a length-wise direction of the array of the unit-cells;
arranging, on the multilayer PCB, a capacitive feed probe configured to be electromagnetically coupled to an aperture of at least the first dipole antenna; and
arranging, on the multilayer PCB, the unit-cells in a periodically repeating manner along at least the length-wise direction, so as to configure a tightly-coupled dipole array.

17. The method according to claim 16, further comprises:
arranging, on the multilayer PCB, a floating patch layer defining a floating patch plane parallel to the dipole antenna plane and the ground plane for each unit-cell, the the floating patch layer comprising a floating patch having two separate floating patch elements above the first dipole antenna.

18. The method according to claim 17, wherein the unit-cells being arranged in the periodically repeating manner along at least the length-wise direction comprises arranging the unit-cells such that a floating patch element in a unit-cell is connected to the nearest floating patch element in a neighboring unit-cell.

19. The method according to claim 17, wherein arraning a floating patch layer defining a floating patch plane parallel to the dipole antenna plane and the ground plane for each unit-cell comprises:
separating the two floating patch elements in a floating patch with a gap in the length-wise direction.

20. The method according to claim 17, further comprises:
arranging, on the multilayer PCB, each unit-cell with a pitch defined by a span of the corresponding floating patch in the length-wise direction.
